(19) United States
(12) Patent Application Publication
(10) Pub. No.: US 2024/0125906 A1
(43) Pub. Date: Apr. 18, 2024

(54) LIDAR SYSTEMS AND METHODS WITH IMPROVED EYE SAFETY

(71) Applicant: Neural Propulsion System, Inc., Pleasanton, CA (US)

(72) Inventors: Daryoosh REJALY, Mountain House, CA (US); Oguzhan TEKE, Pasadena, CA (US); Daniel M. BROWN, Gurley, AL (US); Babak HASSIBI, San Marino, CA (US); Behrooz REZVANI, Petaluma, CA (US)

(73) Assignee: Neural Propulsion Systems, Inc., Pleasanton, CA (US)

(21) Appl. No.: 18/547,362

(22) PCT Filed: Feb. 22, 2022
(86) PCT No.: PCT/US2022/017299

§ 371 Date: Aug. 22, 2023

Related U.S. Application Data
(60) Provisional application No. 63/152,778, filed on Feb. 23, 2021.

(51) Int. Cl. G01S 7/484; G01S 7/481; G01S 17/931

(52) U.S. Cl. CPC G01S 7/484; G01S 7/4815; G01S 7/4816; G01S 17/931

(57) ABSTRACT

Disclosed herein are optical systems (e.g., LiDAR systems) and methods with improved eye safety. In some embodiments, a system includes a first light emitter configured to illuminate a first field of view (FOV) using light emitted at a first wavelength and a second light emitter configured to illuminate a second FOV using light emitted at a second wavelength. The second FOV is wider than the first FOV, and the first FOV extends to a further distance from the system than the second FOV. The system also includes a sensor configured to detect reflections off of targets within the second FOV, and at least one processor configured to execute one or more machine executable instructions. The instructions cause the at least one processor to cause the second light emitter to illuminate the second FOV using the light emitted at the second wavelength, determine whether the sensor detected an object within the second FOV, and in response to determining that the sensor detected the object within the second FOV, prevent the first light emitter from illuminating the first FOV.

### CROSS-REFERENCE TO RELATED APPLICATIONS

This application claims priority from, and hereby incorporates by reference in its entirety for all purposes, U.S. Provisional Application No. 63/152,778, filed 23 Feb. 2021 and entitled “Eye Safety for LiDAR” (Attorney Docket No. NPS008P).

### BACKGROUND

There is an ongoing demand for three-dimensional (3D) object tracking and object scanning for various applications, one of which is autonomous driving. The wavelengths of some types of signals, such as radar, are too long to provide the sub-millimeter resolution needed to detect smaller objects. Light detection and ranging (LiDAR) systems use optical wavelengths that can provide finer resolution than other types of systems, thereby providing good range, accuracy, and resolution. In general, LiDAR systems illuminate a target area or scene with pulsed laser light and measure how long it takes for reflected pulses to be returned to a receiver.

One aspect common to certain conventional LiDAR systems is that the beams of light emitted by different lasers are very narrow and are emitted in specific, known directions so that pulses emitted by different lasers at or around the same time do not interfere with each other. Each laser has a detector situated in close proximity to the laser to detect reflections of the pulses emitted by the laser. Because the detector is presumed only to sense reflections of pulses emitted by the laser, the locations of targets that reflect the emitted can be determined unambiguously. The time between when the laser emitted a light pulse and the detector detected a reflection provides the round-trip time to the target, and the direction in which the emitter and detector are oriented allows the position of the target to be determined. If no reflection is detected, it is assumed there is no target.

Exposure to light emitted by the lasers used in LiDAR systems can cause significant damage to the eyes. The damage is typically in the form of burns and laser energy absorbed by the retina, which can cause permanent damage. There is, therefore, an ongoing need to improve the eye safety of LiDAR systems.

### SUMMARY

This summary represents non-limiting embodiments of the disclosure.

In some aspects, the techniques described herein relate to a system, including: a first light emitter configured to illuminate a first field of view (FOV) using light emitted at a first wavelength; a second light emitter configured to illuminate a second FOV using light emitted at a second wavelength, wherein the second FOV is wider than the first FOV, and wherein the first FOV extends to a further distance from the system than the second FOV; a sensor configured to detect reflections off of targets within the second FOV; and at least one processor configured to execute one or more machine-executable instructions that, when executed, cause the at least one processor to: cause the second light emitter to illuminate the second FOV using light emitted at the second wavelength, determine whether the sensor detected an object within the second FOV, and in response to determining that the sensor detected the object within the second FOV, prevent the first light emitter from illuminating the first FOV.

In some aspects, the techniques described herein relate to a system, wherein the second wavelength is longer than the first wavelength.

In some aspects, the techniques described herein relate to a system, wherein the second wavelength is greater than approximately 1500 nm. In some aspects, the techniques described herein relate to a system, wherein second wavelength is in an 800-nm or a 900-nm band.

In some aspects, the techniques described herein relate to a system, wherein a portion of the first FOV overlaps a portion of the second FOV.

In some aspects, the techniques described herein relate to a system, wherein preventing the first light emitter from illuminating the first FOV includes causing the first light emitter to shut down.

In some aspects, the techniques described herein relate to a system, wherein the first light emitter is one of a plurality of light emitters of a main system, and the second light emitter is included in an auxiliary system.

In some aspects, the techniques described herein relate to a system, wherein the auxiliary system includes at least one range finder, and wherein the second light emitter is included in the at least one range finder. In some aspects, the techniques described herein relate to a system, wherein the auxiliary system includes a LiDAR system, and wherein the second light emitter is included in the LiDAR system.

In some aspects, the techniques described herein relate to a system, wherein the second light emitter includes a Class 1 laser.

In some aspects, the techniques described herein relate to a system, wherein preventing the first light emitter from illuminating the first FOV includes shutting down a subset of the plurality of light emitters of the main system, wherein the subset of the plurality of light emitters illuminates the first FOV.

In some aspects, the techniques described herein relate to a system, wherein preventing the first light emitter from illuminating the first FOV includes shutting down the plurality of light emitters of the main system.

In some aspects, the techniques described herein relate to a system, wherein the system is a light detection and ranging (LiDAR) system, and wherein the second wavelength is greater than approximately 1500 nm.

In some aspects, the techniques described herein relate to a system, wherein at least one of the first light emitter or the second light emitter includes a laser. In some aspects, the techniques described herein relate to a system, wherein the sensor includes a photodiode.

In some aspects, the techniques described herein relate to a system, wherein the first light emitter is configured to operate in at least two modes, the at least two modes including (a) a full-power, full-sequence mode and (b) a reduced-power mode, and wherein, when executed by the at least one processor, the one or more machine-executable instructions further cause the at least one processor to: in response to determining that the sensor did not detect the object within the second FOV, cause the first light emitter to emit one or more probe shots in the reduced-power mode, determine, based on reflections of the one or more probe shots, whether the object is within a hazardous range of the system within the first FOV, and in response to determining that the object is not within the hazardous range of the system within the first FOV, cause the first light emitter to operate in the full-power, full-sequence mode.

In some aspects, the techniques described herein relate to a system, wherein the one or more probe shots include emissions at lower peak power and/or with fewer pulses than emissions in the full-power, full-sequence mode.

In some aspects, the techniques described herein relate to a system, wherein, when executed by the at least one processor, the one or more machine-executable instructions further cause the at least one processor to: in response to determining that the object is within the hazardous range of the system within the first FOV, cause the first light emitter to continue to operate in the reduced-power mode.

In some aspects, the techniques described herein relate to a system, wherein the sensor is a first sensor, and further including: a second sensor configured to detect a third FOV, the third FOV being wider than and overlapping a portion of the first FOV; and wherein, when executed by the at least one processor, the one or more machine-executable instructions further cause the at least one processor to: determine whether the second sensor detected a target within the third FOV.

In some aspects, the techniques described herein relate to a system, wherein, when executed by the at least one processor, the one or more machine-executable instructions further cause the at least one processor to: in response to determining that the second sensor detected the target within the third FOV, cause the first light emitter to continue to operate in the reduced-power mode.

In some aspects, the techniques described herein relate to a system, further including a third light emitter, and wherein, when executed by the at least one processor, the one or more machine-executable instructions further cause the at least one processor to: cause the third light emitter to illuminate a fourth FOV, wherein the fourth FOV is wider than the first FOV, and wherein the fourth FOV overlaps the first FOV and the third FOV.

In some aspects, the techniques described herein relate to a system, wherein the third light emitter and the second sensor are included in a LiDAR system.

In some aspects, the techniques described herein relate to a system, wherein the third light emitter is the second light emitter, and the third FOV is the second FOV.

In some aspects, the techniques described herein relate to a method performed by a light-emitting system to improve eye safety of the light-emitting system, the method including: a first light emitter illuminating a first field of view (FOV) using light emitted at a first wavelength; a second light emitter illuminating a second FOV using light emitted at a second wavelength, wherein the second FOV is wider than the first FOV, and wherein the first FOV extends to a further distance from the light-emitting system than the second FOV; determining whether an object is within the second FOV; and in response to determining that the object is within the second FOV, shutting down the first light emitter.

In some aspects, the techniques described herein relate to a method, wherein the second wavelength is longer than the first wavelength. In some aspects, the techniques described herein relate to a method, wherein the second wavelength is greater than approximately 1500 nm.

In some aspects, the techniques described herein relate to a method, wherein a portion of the first FOV overlaps a portion of the second FOV.

In some aspects, the techniques described herein relate to a method, wherein the first light emitter is one of a plurality of light emitters of a main system, and the second light emitter is included in an auxiliary system.

In some aspects, the techniques described herein relate to a method, wherein the auxiliary system includes at least one range finder, and wherein the second light emitter is included in the at least one range finder. In some aspects, the techniques described herein relate to a method, wherein the auxiliary system includes a LiDAR system, and wherein the second light emitter is included in the LiDAR system.

In some aspects, the techniques described herein relate to a method, wherein the second light emitter includes a Class 1 laser.

In some aspects, the techniques described herein relate to a method, wherein shutting down the first light emitter includes shutting down a plurality of light emitters of the main system.

In some aspects, the techniques described herein relate to a method, wherein the first light emitter is configured to operate in at least two modes, the at least two modes including (a) a full-power, full-sequence mode and (b) a reduced-power mode, and further including: in response to determining that the object is not within the second FOV, the first light emitter emitting one or more probe shots in the reduced-power mode; determining, based on reflections of the one or more probe shots, whether the object is within a hazardous range of the light-emitting system within the first FOV; and in response to determining that the object is not within the hazardous range of the light-emitting system within the first FOV, the first light emitter transitioning to operate in the full-power, full-sequence mode.

In some aspects, the techniques described herein relate to a method, wherein emitting the one or more probe shots in the reduced-power mode includes emitting light at lower peak power and/or with fewer pulses than in the full-power, full-sequence mode.

In some aspects, the techniques described herein relate to a method, further including: in response to determining that the object is within the hazardous range of the light-emitting system within the first FOV, the first light emitter continuing to operate in the reduced-power mode.

In some aspects, the techniques described herein relate to an object-detection system, including: a first light emitter configured to illuminate a first field of view (FOV), wherein the first light emitter is configured to operate in at least two modes, the at least two modes including (a) a full-power, full-sequence mode and (b) a reduced-power mode; a sensor configured to provide a signal indicating presence and/or absence of targets within the first FOV; and at least one processor configured to execute one or more machine-executable instructions that, when executed, cause the at least one processor to: cause the first light emitter to emit one or more probe shots in the reduced-power mode, determine, based on the signal from the sensor, whether there is an object within a hazardous range of the object-detection system within the first FOV, and in response to determining that there is no object within the hazardous range of the object-detection system within the first FOV, cause the first light emitter to operate in the full-power, full-sequence mode.

In some aspects, the techniques described herein relate to an object-detection system, wherein the one or more probe shots include emissions at lower peak power than emissions in the full-power, full-sequence mode.

In some aspects, the techniques described herein relate to an object-detection system, wherein the one or more probe shots include emissions with fewer pulses than emissions in the full-power, full-sequence mode.

In some aspects, the techniques described herein relate to an object-detection system, wherein, when executed by the at least one processor, the one or more machine-executable instructions further cause the at least one processor to: in response to determining that the object is within the hazardous range of the object-detection system within the first FOV, cause the first light emitter to continue to operate in the reduced-power mode.

In some aspects, the techniques described herein relate to a system, wherein the sensor is a first sensor, and further including: a second sensor configured to detect a second FOV, the second FOV being wider than and overlapping a portion of the first FOV; and wherein, when executed by the at least one processor, the one or more machine-executable instructions further cause the at least one processor to: determine whether the second sensor detected a target within the second FOV.

In some aspects, the techniques described herein relate to a system, wherein, when executed by the at least one processor, the one or more machine-executable instructions further cause the at least one processor to: in response to determining that the second sensor detected the target within the second FOV, cause the first light emitter to continue to operate in the reduced-power mode.

In some aspects, the techniques described herein relate to a system, further including a third light emitter, and wherein, when executed by the at least one processor, the one or more machine-executable instructions further cause the at least one processor to: cause a second light emitter to illuminate a third FOV, wherein the third FOV is wider than the first FOV, and wherein the third FOV overlaps the first FOV and the second FOV.

In some aspects, the techniques described herein relate to a system, wherein the second light emitter and the second sensor are included in a LiDAR system.

### BRIEF DESCRIPTION OF THE DRAWINGS

Objects, features, and advantages of the disclosure will be readily apparent from the following description of certain embodiments taken in conjunction with the accompanying drawings in which:

FIG. 1A illustrates some components of an example LiDAR system in accordance with some embodiments.

FIG. 1B illustrates certain components of an example LiDAR system in accordance with some embodiments.

FIG. 1C illustrates a portion of an example LiDAR system in accordance with some embodiments.

FIG. 1D illustrates some components and fields of view an example LiDAR system in accordance with some embodiments.

FIG. 2 illustrates the boundary of the hazardous range of a LiDAR system and the effect of the application of second-order protection in accordance with some embodiments.

FIG. 3 illustrates the minimum-range problem.

FIG. 4 is another illustration of the minimum-range problem.

FIG. 5 illustrates one example approach to address the minimum-range problem in accordance with some embodiments.

FIG. 6 illustrates another example approach to address the minimum-range problem in accordance with some embodiments.

FIG. 7 illustrates another example approach to address the minimum-range problem in accordance with some embodiments.

FIGS. 8A and 8B together illustrate a flow diagram of an example method using both first-order and second-order protection in accordance with some embodiments.

FIG. 9 illustrates an example of first- and second-order protection features and characteristics in accordance with some embodiments.

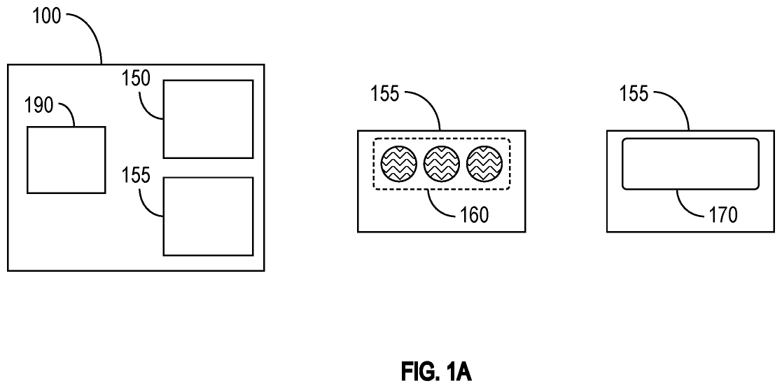

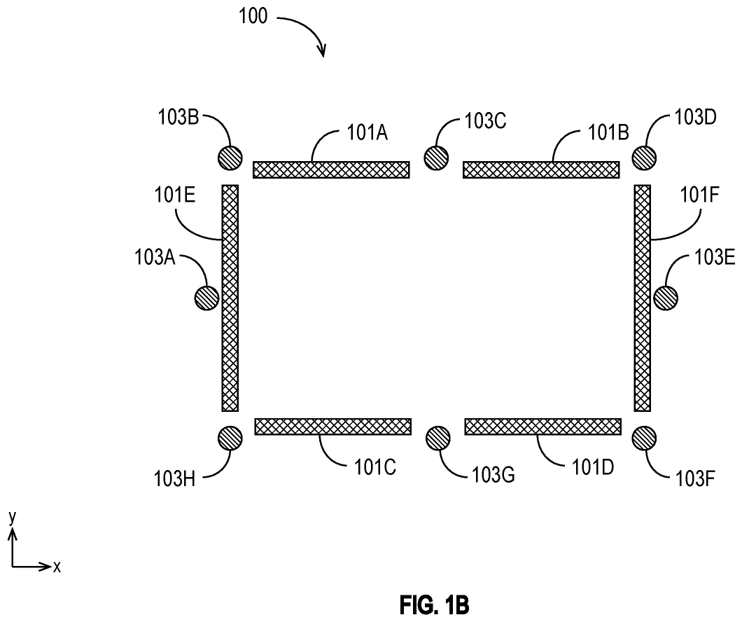

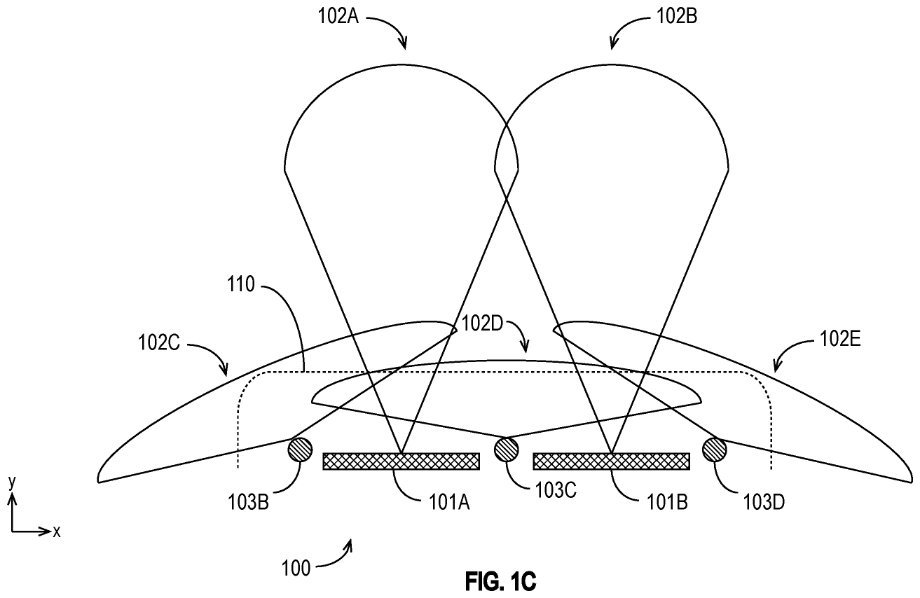

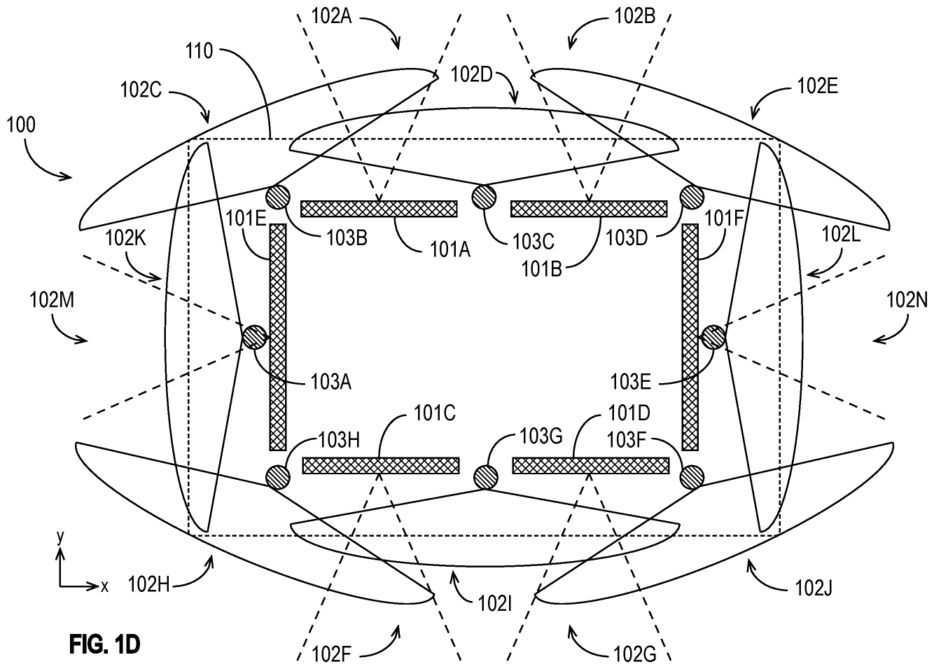

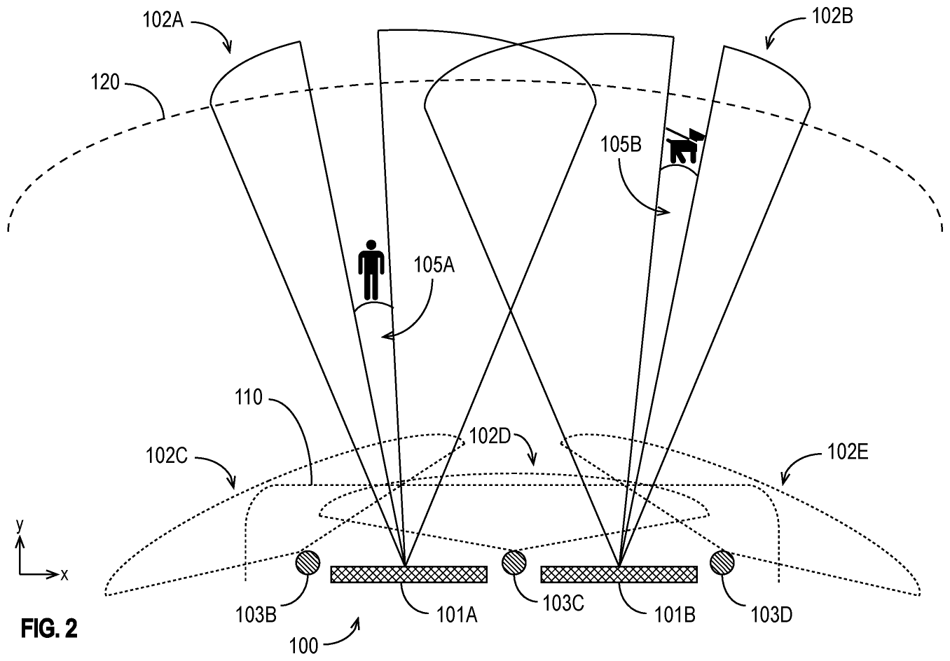

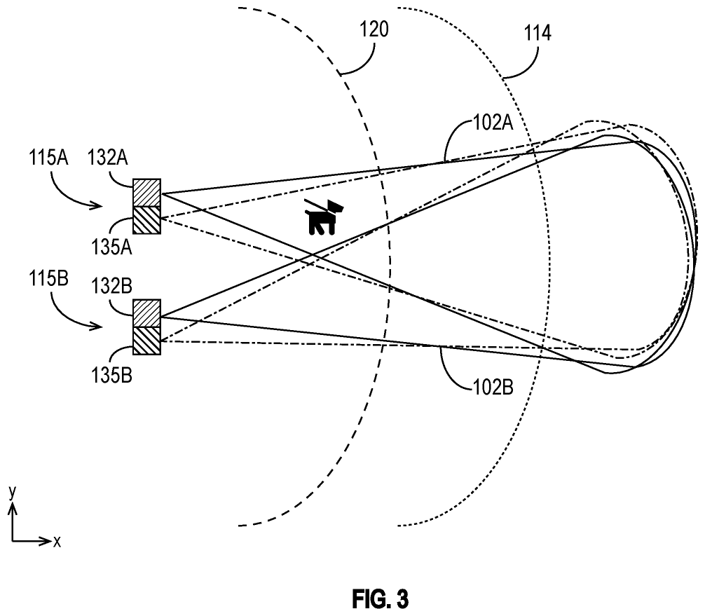

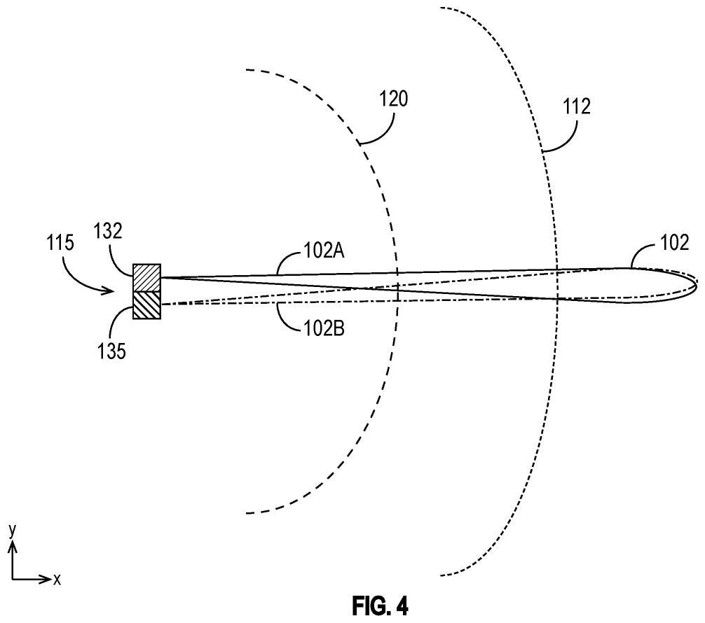

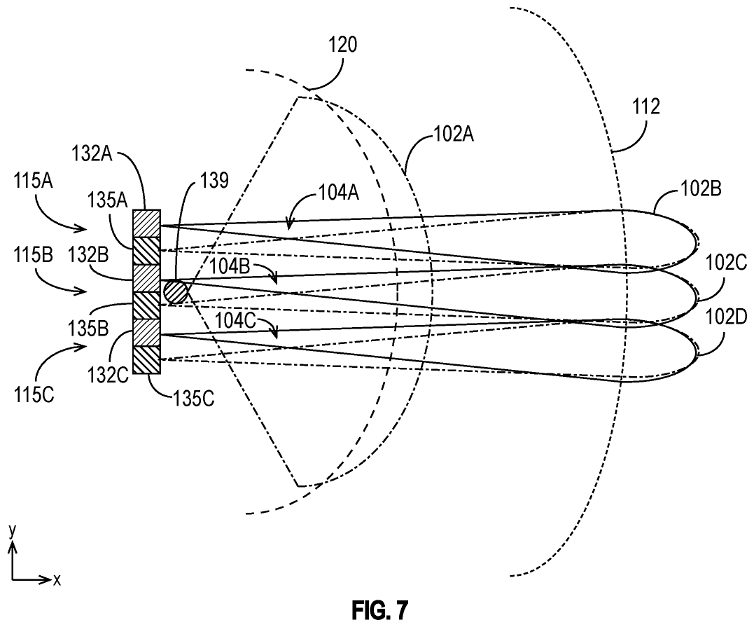

To facilitate understanding, identical reference numerals have been used, where possible, to designate identical elements that are common to the figures. It is contemplated that elements disclosed in one embodiment may be beneficially utilized in other embodiments without specific recitation. Moreover, the description of an element in the context of one drawing is applicable to other drawings illustrating that element. Letters after reference numerals are used herein to distinguish between instances of an element (e.g., fields of view, emitters, detectors, etc.) in individual figures and are not necessarily consistent from figure to figure (e.g., the FOV 102A in FIG. 1C is not necessarily the same FOV as the FOV 102A shown in FIG. 4, the light emitter 132A in FIG. 3 is not necessarily the same light emitter as the light emitter 132A in FIG. 7, etc.). It is to be appreciated that components labeled with one reference numeral in one figure may be, but are not required to be, the same as components labeled with another reference numeral in another figure. As a specific example, the light emitters 101 shown in, for example, FIGS. 1B-2, may be, but are not required to be, identical to the light emitters 132, 132A, 132B, etc. shown in FIGS. 3-7.

### DETAILED DESCRIPTION

LiDAR systems use one or more light sources (e.g., lasers) to emit light and one or more detectors (e.g., photodiode(s)) to detect reflections off of targets (also referred to herein as objects) in a scene. The following description sometimes assumes that the light source(s) are lasers, but it is to be understood that other light sources could be used. Similarly, although the description sometimes assumes that the detectors (also referred to as sensors) are photodiodes, it is to be understood that other detectors could be used.

The light emitted by the lasers used in LiDAR systems can cause significant and/or permanent damage to the eyes, typically in the form of burns and laser energy absorbed by the retina. One reason lasers can be dangerous to eyesight is that their light is collimated into a small beam, unlike the diffuse light emitted by, for example, a light bulb. Another reason lasers can be dangerous for eyesight is their lack of visibility. Because the emitted light is outside of the visible light spectrum, a person or animal can unknowingly stare directly into the beam of an infrared laser.

Lasers emitting light at wavelengths from 400 nm to around 1400 nm (1.4 μm), including many used in conventional LiDAR systems, can be especially problematic. Light emitted at these wavelengths travels directly through the eye's lens, cornea, and intraocular fluid to reach the retina. Light having wavelengths longer than about 1400 nm is less dangerous to the eyes because it is mainly absorbed in the cornea and lens as heat, which may cause corneal burns but prevents most of the energy from reaching the cornea. It is, therefore, safer for eyes to be exposed to longer-wavelength laser light for a longer exposure time and/or at a higher power level.

Disclosed herein are systems, apparatuses, and methods of improving the eye safety of LiDAR systems by using one or both of two types (or orders) of approaches. The two approaches are referred to herein as first-order protection and second-order protection. The purpose of first-order protection is to mitigate negative effects (e.g., on eye safety) of the LiDAR system on objects at close distances, where “close” is context specific (e.g., in a LiDAR system used for autonomous driving, objects that are at a close distance may be those less than 1 meter from the vehicle, whereas in other types of systems, “close” may be considered to be objects closer to or further away from the optical system).

First-order protection operates to improve eye safety within a specified (e.g., defined) range of the LiDAR (or other type of optical) system, referred to herein as the “shutdown range.” In response to detecting objects within the shutdown range, some or all of the lasers emitting light within the shutdown range can be prevented from emitting light while objects are detected within the shutdown range. The use of first-order protection can mitigate or prevent accidents and/or harm to eyes if, for example, a curious adult, animal, or child places his eyes near an emitting laser in the event his presence was not otherwise detected while he was at a further distance away from the optical system.

The purpose of second-order protection is to improve eye safety in what may be referred to as the “hazardous range” of a LiDAR (or other type of optical) system's field of view (FOV), or in a portion of the overall system's FOV. The hazardous range extends further from the LiDAR system than the shutdown range (e.g., the hazardous range may be a middle range of the system). In response to detecting objects within the hazardous range, within a FOV, the power(s) of the lasers that are illuminating that FOV in which one or more objects were detected within the hazardous range can be reduced.

The two-order approach described herein allows the system to have fast reaction time to mitigate harm to objects at distances close to an optical transmitting system (e.g., a LiDAR system). For example, the disclosed techniques can be used to improve eye safety for humans and animals as close as about 1 cm from the system.

It is to be appreciated that the first-order protection described herein can be used without the second-order protection, and vice versa. In other words, although a system using both types of protection may be advantageous, systems may also benefit by less than all of the disclosed eye-protection approaches.

FIG. 1A illustrates an example LiDAR system 100 in accordance with some embodiments. The LiDAR system 100 comprises a main system 150, an auxiliary system 155, and at least one processor 190. The main system 150 may be or comprise, for example, a long-range LiDAR system. The at least one processor 190 is configured to execute machine-executable instructions that may be, for example, stored in memory (e.g., in an integrated circuit, in a memory chip or circuit on a printed circuit board, etc.). In operation, the at least one processor 190 executes one or more machine-executable instructions that cause the at least one processor 190 to, among other things, control and direct the actions of the main system 150 and the auxiliary system 155. FIG. 1A shows the main system 150, the auxiliary system 155, and the at least one processor 190 as separate blocks of the LiDAR system 100, but it is to be appreciated that this presentation is for convenience. In an implementation of the LiDAR system 100, some or all of the main system 150, auxiliary system 155, and/or at least one processor 190 may be integrated together (e.g., in an integrated circuit, array, etc.), components may be shared, etc. For example, the main system 150 and/or the auxiliary system 155 may include some or all of the at least one processor 190, and/or the at least one processor 190 may comprise one or more processors included in the main system 150 and/or one or more processors in the auxiliary system 155. Similarly, as described further below, in embodiments that use a short-range LiDAR system to provide or assist in providing first-order protection and/or second-order protection, that short-range LiDAR system may be part of the perception system (e.g., used to detect objects close to the LiDAR system 100).

### First-Order Protection

The auxiliary system 155 can be used to provide first-order protection as described herein. The range addressed by first-order protection is expected to be close to the LiDAR system 100. As explained further below, first-order protection can be achieved by the auxiliary system 155 using, for example, one or more dedicated range finders (e.g., using a wavelength greater than 1500 nm (e.g., 1550 nm) or another eye-safe wavelength) or a short-range LiDAR system that may also be part of the perception system.

As shown in FIG. 1A, the auxiliary system 155 can include, for example, one or more dedicated range finders 160 that can be used to improve eye safety within the shutdown range. The one or more dedicated range finders 160 can be used to detect objects (e.g., people, animals, etc.) within the shutdown range. As will be appreciated by those having ordinary skill in the art, a range finder emits electromagnetic pulses that are reflected off of a target's surface and return to the range finder. The time between when the pulses are emitted and when the reflections are detected can be used to measure the distance to the target. In response to the one or more dedicated range finders 160 detecting at least one object within the shutdown range, the at least one processor 190 may cause some or all lasers (or, generally, emitters) of the main system 150 to be shut down (e.g., prevented from emitting light). For example, in response to the one or more dedicated range finders 160 detecting at least one object within the shutdown range, the at least one processor 190 may cause all of the lasers in the main system 150 to be shut down. Alternatively, the at least one processor 190 can cause a subset of the lasers of the main system 150 to be shut down. For example, the at least one processor 190 may cause only some or all of the lasers of the main system 150 that are illuminating the particular field of view within the shutdown range in which the object was (or objects were) detected to be shut down, while leaving the remaining lasers on. The shutdown may be for a predetermined amount of time, or it may continue for as long as one or more objects continue to be detected in the FOV. The at least one processor 190 can reactivate particular lasers when the one or more dedicated range finders 160 detect that the object is no longer in the FOV or has moved such that reactivating the particular shut-down lasers of the main system 150 is safe.

As also shown in FIG. 1A, the auxiliary system 155 can alternatively or additionally comprise a short-range LiDAR system 170 that can be used to detect objects in the shutdown range. The auxiliary system 155 can include the short-range LiDAR system 170 in addition to, or instead of, the one or more dedicated range finders 160. If present, the short-range LiDAR system 170 can use, for example, a Class 1 laser. As will be appreciated by those having ordinary skill in the art, a Class 1 laser is generally considered to be eye-safe under all conditions of normal use. The wavelength of the short-range LiDAR system 170 can be, for example, in the 800-nm or 900-nm band (e.g., 850 nm, 905 nm, 940 nm, etc.). It is to be appreciated that the wavelengths given herein are merely examples, and other wavelengths may be used.

It is also to be appreciated that, as used herein, the terms “short-range” and “long-range” are context-dependent and relative (e.g., to each other). For example, in a LiDAR system 100 intended for autonomous driving applications, the main system 150 may be a long-range LiDAR system capable of detecting objects at distances between, for example, approximately 200 m and approximately 1 km, whereas the short-range LiDAR system 170 may be configured to detect objects at distances between, for example, approximately 1 meter and approximately 200 m. It is to be appreciated that in embodiments that include both a long-range LiDAR system and a short-range LiDAR system 170, there may be overlap in the ranges that can be detected by the two systems (e.g., the short-range LiDAR system 170 may be capable of detecting objects at distances that are also within the range of the long-range LiDAR system, or vice versa).

FIG. 1B illustrates certain components of an example LiDAR system 100 in accordance with some embodiments. The LiDAR system 100 may be situated, for example, on a vehicle, such as a car (not illustrated) that can move, for example, forward, backward, left, and/or right in an x-y plane. Although not specifically illustrated in FIG. 1B, the example LiDAR system 100 shown in FIG. 1B includes at least one processor 190, a main system 150, and an auxiliary system 155. As explained above, the main system 150 may be a long-range LiDAR system (where, as explained above, “long-range” is context-dependent). As also explained above, the at least one processor 190 can control the operation of the main system 150 and/or the auxiliary system 155. As also explained above, the auxiliary system 155 may include one or both of the short-range LiDAR system 170 and/or one or more dedicated range finders 160. If present, the short-range LiDAR system 170 can be used both to improve eye safety as described herein (e.g., in one or both of the shutdown range 110 and the hazardous range 120, as described further below) and to detect the positions of objects/targets relative to the LiDAR system 100.

The main system 150 includes a plurality of light emitters 101, illustrated as rectangles in FIG. 1B, and the auxiliary system 155 includes a plurality of one or more object-detection components 103, illustrated as circles in FIG. 1B. The one or more object-detection components 103 can be or comprise, for example, one or more dedicated range finders 160 and/or components of a short-range LiDAR system 170.

FIG. 1B shows the light emitter 101A, the light emitter 101B, the light emitter 101C, the light emitter 101D, the light emitter 101E, and the light emitter 101F, and the object-detection component 103A, the object-detection component 103B, the object-detection component 103C, the object-detection component 103D, the object-detection component 103D, the object-detection component 103F, the object-detection component 103G, and the object-detection component 103H. It is to be appreciated that FIG. 1B shows an example LiDAR system 100 with example components of the main system 150 and auxiliary system 155, and a LiDAR system 100 may include fewer or more components than shown in FIG. 1B. For example, the LiDAR system 100 may include fewer or more light emitters 101 and fewer or more object-detection components 103 than shown in FIG. 1B. Moreover, it is to be appreciated that the light emitters 101 can be or include one or more arrays of light emitters 101, and the one or more object-detection components 103 can be or include one or more arrays of one or more object-detection components 103. In particular, as an example, the light emitters 101 can be an array comprising the light emitters 132, light emitter 132A, light emitter 132B, etc. discussed below in the context of, e.g., FIGS. 3-7. Alternatively, or in addition, certain of the light emitters 101 illustrated in FIG. 1B (and other figures discussed below) can be single light emitters, such as, for example, the light emitter 132A, light emitter 132B, etc. discussed below in the context of, e.g., FIGS. 3-7. It is to be appreciated that the one or more object-detection components 103 can include some type of emitter (e.g., a laser) and/or some type of sensor (e.g., a photodiode). It is also to be appreciated that the main system 150 includes other components (e.g., sensors) that are not illustrated in FIG. 1B. In addition, the LiDAR system 100 includes other components, such as, for example, at least one processor 190.

FIG. 1C shows a portion of the example LiDAR system 100 of FIG. 1B to illustrate the various fields of view (FOVs) of the components in accordance with some embodiments. As illustrated in FIG. 1C, the light emitter 101A has a FOV 102A, the light emitter 101B has a FOV 102B, the object-detection component 103B has a FOV 102C, the object-detection component 103C has a FOV 102D, and the object-detection component 103D has a FOV 102E. It is to be appreciated that, in general, each of the FOVs 102 will occupy a respective volume of space, and FIG. 1C is merely a two-dimensional representation. As shown, the FOVs 102 of the main system 150 components extend to a further distance than do the FOVs 102 of the auxiliary system 155. Specifically, as shown in FIG. 1C, the FOV 102A of the light emitter 101A and the FOV 102B of the light emitter 101B extend further from the LiDAR system 100 than do the FOV 102C of the object-detection component 103B, the FOV 102D of the object-detection component 103C, and the FOV 102E of the object-detection component 103D. The object-detection component 103B, object-detection component 103C, and object-detection component 103D (and any other one or more object-detection components 103 of the LiDAR system 100) are situated in the LiDAR system 100 and configured so that in operation the FOV 102C, FOV 102D, and FOV 102E illuminate a shutdown range 110 of the LiDAR system 100.

FIG. 1C illustrates a portion of a boundary of the shutdown range 110. In the example of FIG. 1C, the shutdown range 110 is shown as essentially being a rectangle that extends to roughly the same distance around the LiDAR system 100, but it is to be appreciated that the shutdown range 110 can have any suitable size and shape. For example, the shutdown range may be larger in some directions than in others. Similarly, its shape in the x-y plane may be regular or irregular. The shutdown range 110 can be determined, and the characteristics of the one or more object-detection components 103 selected, to suit application needs. Similarly, there is no requirement for the shutdown range 110 to be continuous around the LiDAR system 100. There may be applications in which there is no shutdown range in some directions (e.g., to the sides of the LiDAR system 100). The shutdown range 110 may be determined, for example, based on the characteristics of the main system 150 and/or the environment in which the LiDAR system 100 is expected to operate.

FIG. 1D illustrates the FOVs 102 of the example LiDAR system 100 of FIG. 1B. As illustrated in FIG. 1D, each of the light emitters 101 of the main system 150 and each of the one or more object-detection components 103 of the auxiliary system 155 has a respective FOV 102. The illustrated portions of the FOVs 102 of the light emitters 101 of the main system 150 are shown in long-dashed lines to distinguish them from the FOVs 102 of the one or more object-detection components 103 of the auxiliary system 155. Specifically, the light emitter 101A has a FOV 102A, the light emitter 101B has a FOV 102B, the light emitter 101C has a FOV 102F, the light emitter 101D has a FOV 102G, the light emitter 101E has a FOV 102M, and the light emitter 101F has a FOV 102N. The object-detection component 103A has a FOV 102K, the 103B has a FOV 102C, the object-detection component 103C has a FOV 102D, the object-detection component 103D has a FOV 102E, the object-detection component 103E has a FOV 102L, the object-detection component 103F has a FOV 102J, the object-detection component 103G has a FOV 102I, and the object-detection component 103H has a FOV 102H. FIG. 1D also illustrates the outer boundary of an example shutdown range 110 in accordance with some embodiments.

As shown in FIGS. 1B and 1C, light emitters 101 (e.g., lasers or another suitable component) of the main system 150 illuminate respective fields of view 102, which extend some distance from the LiDAR system 100. It is to be appreciated that one or more of the light emitters 101 shown in FIGS. 1B, 1C, and 1D may represent an array (e.g., a plurality) of light emitters 101 that together provide the illustrated FOV 102.

As compared to the FOVs 102 of the light emitters 101 of the main system 150, the one or more object-detection components 103 of the auxiliary system 155 shown in FIG. 1D illuminate wider FOVs 102 that extend to distances closer to the LiDAR system 100 than the FOVs 102 of the light emitters 101. It is to be appreciated that the FOVs 102 of the one or more object-detection components 103 may be wider than the FOVs 102 of the light emitters 101 in any direction (e.g., azimuth, elevation, or any combination). Moreover, the FOVs 102 of the one or more object-detection components 103 may be wider than the FOVs 102 of the light emitters 101 in some directions but not necessarily in all directions. For example, the FOVs 102 of the one or more object-detection components 103 may be wider in the azimuth direction but not necessarily in the elevation direction.

The FOVs 102 of the one or more object-detection components 103 extend at least to the shutdown range 110 (represented by the short-dashed line in FIGS. 1C and 1D). As explained above, the one or more object-detection components 103 may include, for example, dedicated one or more dedicated range finders 160 that detect objects within the shutdown range. Alternatively, or in addition, they may be components of a short-range LiDAR system 170 that detects objects in the shutdown range 110.

The number and FOVs 102 of the one or more object-detection components 103 can be selected to meet design objectives or constraints. For some applications, it may be desirable for the one or more object-detection components 103 to illuminate the entirety of a volume of space in some directions but not others. For example, for a LiDAR system 100 mounted on a vehicle for autonomous driving, it may be desirable for the one or more object-detection components 103 to illuminate as much of the volume of space as feasible between the LiDAR system 100 and the boundary of the shutdown range 110 in front of and behind the LiDAR system 100, but less than all of the volume of space to the sides of the LiDAR system 100. For example, if the LiDAR system 100 is mounted on a vehicle (e.g., at bumper height, or between 10 inches (about 25 cm) off of the ground and 3 feet (about 0.9 m) above the ground, etc.), it may be desirable to illuminate the entire volume in front of and behind the LiDAR system 100. In some circumstances, it may be desirable to provide some, but not complete, coverage to the sides of the LiDAR system 100 (e.g., when mounted on a vehicle). For example, referring to FIG. 1D, if the x-direction represents the forward and backward directions of a vehicle on which the LiDAR system 100 has been mounted, in some embodiments, the FOV 102H, FOV 102I, and FOV 102J might not overlap in all areas to the side of the LiDAR system 100 and, similarly, the FOV 102C, FOV 102D, and FOV 102E might not overlap in all areas to the side of the LiDAR system 100.

It is to be appreciated that there can be any number of one or more object-detection components 103 in the auxiliary system 155, and their locations and FOVs 102 can be selected to provide whatever is considered, in an application, to be suitable illumination to detect objects within the shutdown range 110. Moreover, different one or more object-detection components 103 of the auxiliary system 155 can have different characteristics (e.g., FOV 102, power, wavelength, etc.). Although all of the one or more object-detection components 103 illustrated in FIG. 1D have FOVs 102 that have roughly the same widths and extend to approximately the same distance from the LiDAR system 100, different one or more object-detection components 103 can have FOVs 102 that extend to different distances. Likewise, the widths of the FOVs 102 of different one or more object-detection components 103 can be different. Generally speaking, the FOVs 102 for different of the one or more object-detection components 103 can be different.

As explained above, in response to detecting an object within the shutdown range 110, some or all of the light emitters 101 emitting light within the shutdown range 110 can be prevented from emitting light while the object is detected within the shutdown range 110. The shutdown may be for a predetermined amount of time, or it may continue for as long as the object is detected in the FOV. The at least one processor 190 can reactivate particular light emitters 101 when the auxiliary system 155 detects that the object is no longer in the FOV or has moved such that reactivating the light emitters 101 of the main system 150 is safe.

One benefit of the first-order protection disclosed herein is that it can be implemented solely in hardware, without any software involved. For example, in response to detecting at least one object within the shutdown range 110, all light emitters 101 illuminating a particular FOV 102 can be shut down, or all light emitters 101 of the main system 150 can be shut down.

To avoid interference with and/or crosstalk to the normal (ordinary) operation of the LiDAR system 100 (e.g., the operation of the main system 150), the one or more object-detection components 103 can emit light at longer wavelengths than the light emitters 101 of the LiDAR system 100 and that are also safer for eyes. For example, assuming the light emitters 101 of the main system 150 operate in the 800-nm or 900-nm band (e.g., emit light having a wavelength of 905 nm), the wavelength for the one or more object-detection components 103 of the auxiliary system 155 may be in the C band (1550 nm band), which is a safer wavelength for eyes.

### Second-Order Protection

As explained above, second-order protection can be used to improve eye safety in the hazardous range of the field of view (FOV) of the LiDAR system 100, or in a portion of the FOV. In response to detecting objects within the hazardous range, the power(s) of some or all light emitters 101 that are illuminating the FOV in which one or more objects were detected within the hazardous range can be reduced.

In some embodiments, the light emitters 101 of the main system 150 are capable of emitting optical signals that are pulse sequences. These pulse sequences can be the same for all of the light emitters 101, or they can be different for different light emitters 101 (e.g., within a particular volume of space, different light emitters 101 can emit different pulse sequences so that their reflections are distinguishable). The pulse sequence used by a particular light emitter 101 may be globally unique, or it may be locally unique (used by multiple light emitters 101, but in such a way that identical pulse sequences are not present in a single FOV 102 at the same time). The pulse sequence(s) are emitted at some power level. In some environments, there may be ranges (distances from the LiDAR system 100) in which emitting light emitters 101 are not eye-safe if operated at full power using full pulse sequences (“full sequence”). The unsafe ranges can differ for different FOVs 102 of the system (e.g., in different directions, for different azimuth and elevation angles, etc.). As described further below, in some embodiments, the emissions of the light emitters 101 are adjusted on the fly, in response to detecting objects within various ranges, to improve eye safety. For example, the power levels of pulse sequences, or the pulse sequences, emitted by light emitters 101 can be reduced or modified so that they pose less or no risk to eyes. The mode in which the light emitters 101 operate using reduced power (e.g., at a lower peak power, and/or with a reduced pulse sequence, etc.) is referred to herein as “probe scanning mode” or “reduced-power mode.”

The purpose of second-order protection is to detect objects in the hazardous range (e.g., medium range of the LiDAR system 100, long range of the LiDAR system 100, any range longer than the shutdown range 110, etc.) of one or more of the FOVs 102. In some embodiments, in response to detecting objects in the hazardous range, the LiDAR system 100 reduces the power of the light emitters 101 of the main system 150 that are illuminating that FOV 102 (or a portion of that FOV 102). During the time that second-order protection is applied, the rest of the LiDAR system 100 (e.g., the main system 150, the auxiliary system 155, and/or other optical system) can continue to operate under normal conditions even if object(s) are in the hazardous range of some FOVs 102. Note that the hazardous range may be specific to particular light emitters 101 (e.g., laser-specific) and/or specific to particular FOVs 102 (e.g., FOV-specific). For example, the hazardous range for FOVs 102 extending in front of an autonomous vehicle on which the LiDAR system 100 is mounted may be different from (e.g., extend further than) the hazardous range(s) for FOVs 102 extending to the sides of or behind the vehicle. Similarly, the hazardous range may depend on the typical or expected power used within particular FOVs 102.

Second-order protection can be performed entirely by the main system 150, or, as explained further below, additional components can be included in the LiDAR system 100 to assist in providing second-order protection. For example, the short-range LiDAR system 170 described above can assist in providing second-order protection. Alternatively, or in addition, at least one wide-FOV detector, described further below, can be provided to detect objects that are illuminated (and thus at risk of eye damage) but are not within any detector FOV of the main system 150.

FIG. 2 illustrates the boundary of the hazardous range 120 of a LiDAR system 100 and the effect of the application of second-order protection in accordance with some embodiments. (To avoid obscuring the portions of FIG. 2 discussed below, the FOVs 102 of the one or more object-detection components 103 of the auxiliary system 155 are shown in dashed lines in FIG. 2.) The LiDAR system 100 shown in FIG. 2 may be, for example, on a vehicle (e.g., a car). Several of the elements illustrated in FIG. 2 were described in the discussion of FIGS. 1A, 1B, 1C, and/or 1D; those descriptions also apply to FIG. 2 and are not repeated here.

As shown in FIG. 2, in response to detecting one or more objects are detected within the hazardous range 120, the power of one or more light emitters 101 illuminating the portion of the FOV 102 in which the object(s) reside can be reduced. FIG. 2 illustrates a person within the FOV 102A of the light emitter 101A and a dog within the FOV 102B of the light emitter 101B. As shown in FIG. 2, the FOV 102A has a reduced-power region 105A to protect the person, and the FOV 102B has a reduced-power region 105B to protect the dog.

The reduced-power region 105A and reduced-power region 105B can be created in any suitable manner. For example, the power of emissions within the FOV 102 of, for example, a single light emitter 101 or an array or plurality of light emitters 101 can be reduced to a level that is more eye-safe to protect a person or an animal in the FOV 102. In some embodiments, at least one of the light emitters 101 is configured to operate in at least two modes, including (a) a full-power, full-sequence mode and (b) a reduced-power (or probe scanning) mode. For example, as described further below, in some embodiments, before emitting light at the full power level (e.g., operating in the full-power, full-sequence mode), the light emitters 101 first emit what are referred to herein as “probe shots” (e.g., in the reduced-power mode). In response to detecting an object within its FOV 102, a light emitter 101 can continue to transmit at the power level used for probe shots, as described further below.

In some embodiments, to implement second-order protection, before each full-power, full-sequence emission or “shot,” the LiDAR system 100 detects whether any object(s) are present in the hazardous range 120. Objects within the hazardous range 120 can be detected, for example, using a “probe shot” from one or more light emitters 101 of the main system 150. A probe shot may be, for example, a single laser pulse with either lower or full peak power that is eye safe at all ranges. For example, each probe shot may have a wavelength that is greater than 1440 nm. In some embodiments, the light emitters 101 are capable of emitting light at different wavelengths, and the wavelength used for probe shots is a longer wavelength than the wavelength used for full-power, full-sequence emissions. In some embodiments, the probe shots have the same wavelength as the full-power, full-sequence emissions, but their sequences are shorter and/or they have fewer pulses and/or their power levels are lower so that they emit a lower average power and/or a lower peak power than full-power, full-sequence emissions.

In some embodiments, before each full-power, full-sequence ranging cycle (which typically includes multiple averaging shots, as described below), the LiDAR system 100 operates in the reduced-power mode and uses at least one probe shot to interrogate one or more of the FOVs 102 for possible objects within the hazardous range 120. In some embodiments, if any objects are detected, each light emitter 101 whose emission resulted in at least one object being detected continues operating in the reduced-power mode (e.g., probe shot mode, using less power, a less full sequence, and/or a safer wavelength for eyes, etc.). In some embodiments, if no objects are detected within the FOV 102 of a particular light emitter 101, the light emitter 101 (e.g., laser) fires full-power, full-sequence shots.

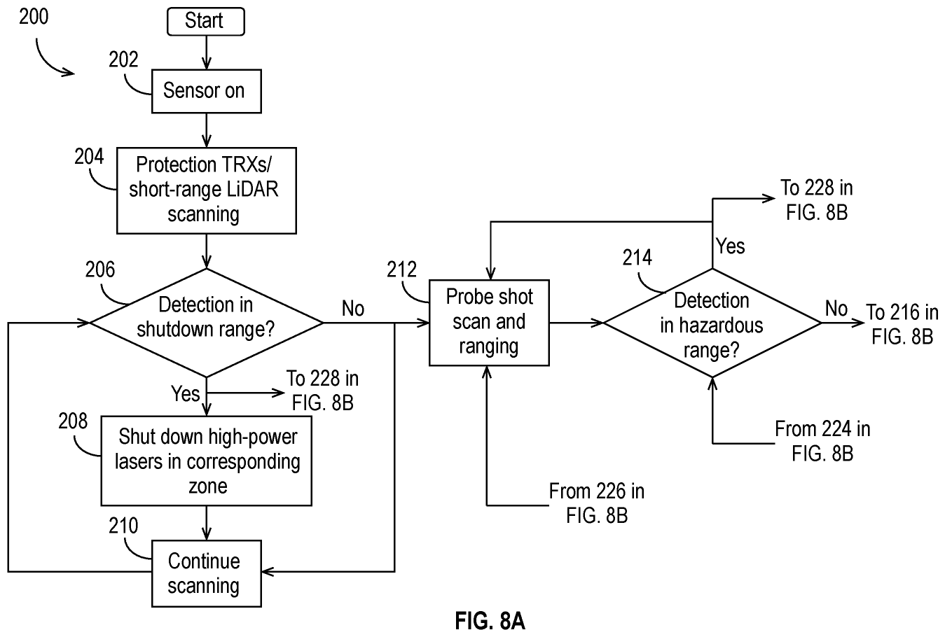

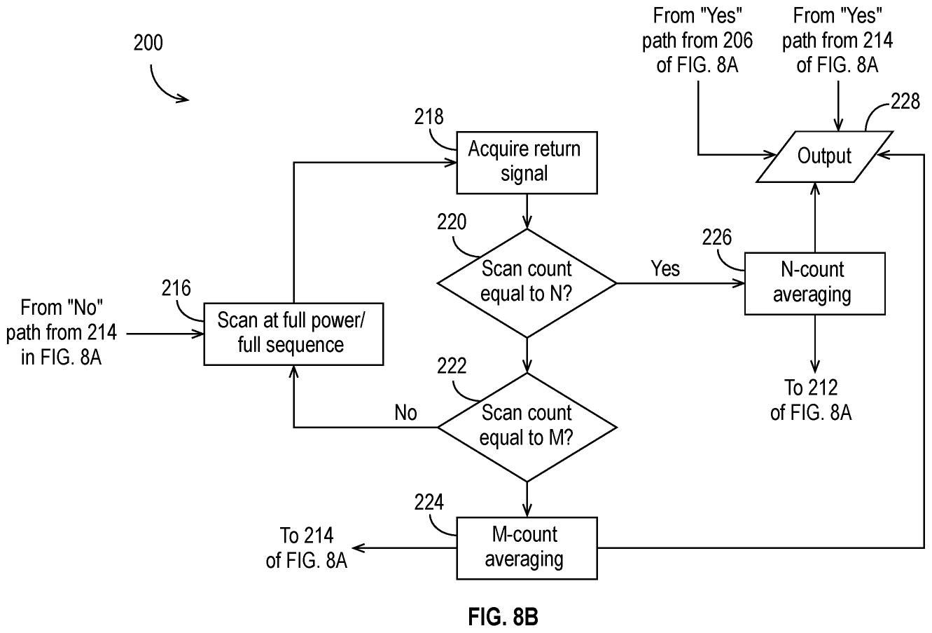

As will be appreciated, in the course of its ordinary operation, the main system 150 may perform averaging to detect targets (e.g., those with low reflectivity). Assuming the maximum number of measurements used in the averaging is N (as described further in the discussion of FIGS. 8A and 8B below), the FOVs 102 can be interrogated within shorter time intervals than taken to complete the entire N-count averaging. As described further below in the discussion of FIG. 8B, after every M-count averaging procedure (where M is less than N), the LiDAR system 100 can check for possible objects within the hazardous range 120 and, if any target is detected, the LiDAR system 100 can discontinue the rest of the averaging process and switch into the probe scanning mode. Thus, for the shots with a high number of averaging, for additional protection, the ranging can be done within the averaging interval to make sure the field of view is still safe for full-power, full-sequence shots.

FIG. 2 shows only a portion of the hazardous range 120 boundary of an example LiDAR system 100. Like the shutdown range 110, the hazardous range 120 need not have a uniform shape around the LiDAR system 100 or extend to a uniform distance from the LiDAR system 100.

As will be appreciated, the main system 150 may have “blind spots” within the hazardous range 120. These blind spots may be, for example, due to the physical distances between individual emitters and detectors. FIGS. 3 and 4 illustrate what is referred to herein as the “minimum-range problem,” which results in blind spots. The minimum-range problem can occur for at least two types of systems: those that use triangulation and long-range flash LiDAR systems.

FIG. 3 illustrates the minimum range problem for a system that uses triangulation. As illustrated in FIG. 3, there are two emitter-sensor pairs 115 with FOVs 102 that overlap in some region (e.g., volume of space). Specifically, in the example of FIG. 3, a first emitter-sensor pair 115A includes a light emitter 132A and a sensor 135A. The light emitter 132A may be, for example, a laser that is capable of emitting a probe shot as described above. The sensor 135A may be, for example, an avalanche photodiode (APD). A second emitter-sensor pair 115B includes a light emitter 132B (e.g., a laser) and a sensor 135B (e.g., an APD), which may be similar or identical to the light emitter 132A and the sensor 135A. The emitter-sensor pair 115A and emitter-sensor pair 115B are offset from each other to allow triangulation. Due to there being physical distance between the two emitter-sensor pairs 115 in the vertical and/or horizontal planes, there is a distance at which the FOVs 102 of both pairs do not have any overlap, or the overlap is incomplete. Triangulation cannot be used to detect objects in the region in which the FOVs 102 do not overlap. The distance at which the two emitter-sensor pairs 115 have close to complete overlap is referred to herein as the minimum range 114.

As shown in FIG. 3, for some FOVs 102, the minimum range 114 at which objects can reliably be detected (e.g., the distance from the LiDAR system 100 from which the FOV 102A and FOV 102B mostly overlap) may be larger than the hazardous range 120. In this case, an object within the hazardous range 120 might not be detected using probe shots from the light emitter 132A or the light emitter 132B. For example, the dog illustrated in FIG. 3 might not be detected because it is “too close” to the LiDAR system 100 (e.g., it is outside of the shutdown range 110 but inside of the hazardous range 120, which is closer to the LiDAR system 100 than the minimum range 114).

FIG. 4 illustrates the minimum range problem for a long-range flash LiDAR system (e.g., when the main system 150 is a flash LiDAR system). As shown in FIG. 4, a single emitter-sensor pair 115 covers a specific FOV 102 that is narrower than the FOV 102A and the FOV 102B shown in FIG. 3. Because there is a distance between the light emitter 132 and the corresponding sensor 135, even if small, there is a region in which the FOV 102A of the light emitter 132 and the FOV 102B of the sensor 135 do not have any overlap, or the overlap is incomplete. As a result, the main system 150 will not (reliably and/or at all) detect targets in this region. The range at which the FOV 102A of the light emitter 132 and the FOV 102B of the corresponding sensor 135 have close to complete overlap is called the minimum detectable range 112. It is to be appreciated that in some long-range flash LiDAR systems, multiple light emitters 132 can be used to illuminate a specific FOV 102, but the minimum range problem will remain due to the physical distance between components.

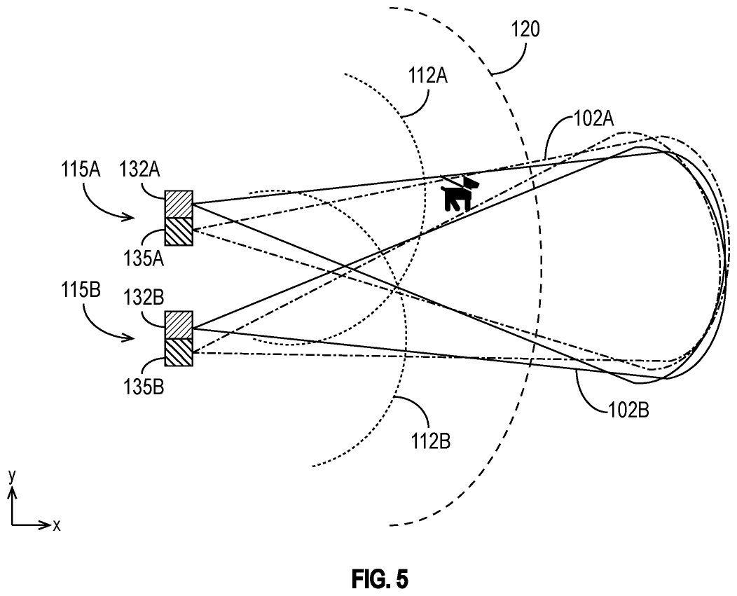

FIG. 5 illustrates one example approach to address the minimum-range problem in accordance with some embodiments. To reduce the minimum range for the probe shots, a non-triangulation range calculation can be performed using two emitter-sensor pairs 115 covering the applicable FOV 102. FIG. 5 illustrates the emitter-sensor pair 115A and minimum detectable range 112A, and the emitter-sensor pair 115B and minimum detectable range 112B. The emitter-sensor pair 115A includes the light emitter 132A and the sensor 135A, and the emitter-sensor pair 115B includes the light emitter 132B and the sensor 135B. In FIG. 5, the dog is situated within the FOV 102A (but outside of the FOV 102B), between the minimum detectable range 112A and the hazardous range 120. The emitter-sensor pair 115A can detect that the dog is within the FOV 102A, even if they cannot determine exactly where within the FOV 102A it is. Note that it is not necessary to know the exact location of the close-by object (e.g., the dog shown in FIG. 5), meaning that triangulation is not necessary. The objective is to identify in which FOV 102 the close-by object is located, which can be determined using only a single emitter-sensor pair 115 (e.g., the emitter-sensor pair 115A or the emitter-sensor pair 115B), so as to take action to improve eye safety for that object, wherever it might be within the FOV 102A.

The approach described immediately above is suitable, for example, when the complete overlap of the FOV 102 of the emitter-sensor pair 115 occurs at closer distances to the LiDAR system 100 than the hazardous range 120. In the case of long-range flash LiDAR systems in which the FOVs 102 of the light emitter 132 and the corresponding sensor 135 are narrower (or in systems with narrower FOVs 102 and using triangulation), the overlap of the FOV 102 of the light emitter 132 and the FOV 102 of the corresponding sensor 135 may occur outside of the hazardous range 120. For longer ranges and/or flash LiDAR systems, the FOVs 102 may be narrower at closer ranges, and, as a result, the overlap of FOVs 102 of multiple emitter-sensor pairs 115 may occur at longer ranges (e.g., for flash LiDAR, the minimum distance may be around 10.7 meters). For example, as explained above, FIG. 4 illustrates an example in which the minimum detectable range 112 is further from the LiDAR system 100 than the hazardous range 120.

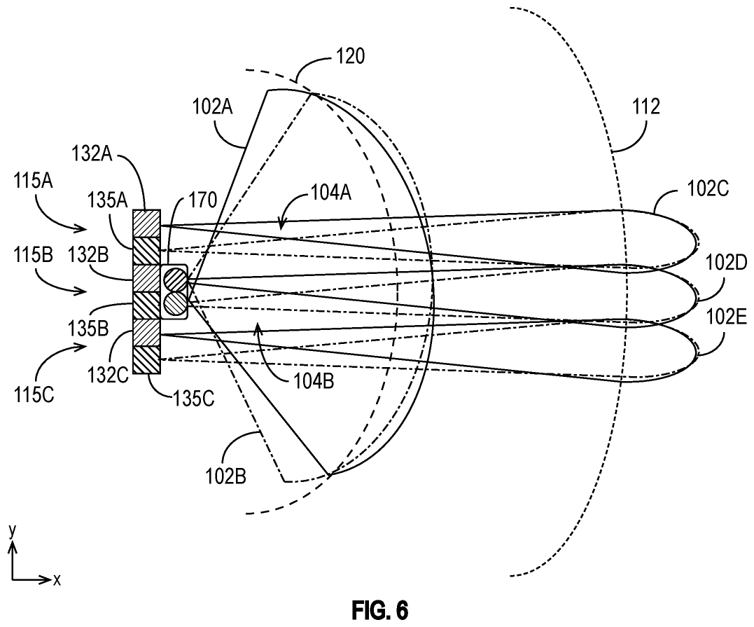

FIG. 6 illustrates another example solution to the minimum range problem, such as with long-range flash LiDAR systems, in accordance with some embodiments. The LiDAR system 100 includes several emitter-sensor pairs 115. FIG. 6 shows three emitter-sensor pairs 115, namely the emitter-sensor pair 115A, the emitter-sensor pair 115B, and the emitter-sensor pair 115C. The emitter-sensor pair 115A includes the light emitter 132A and the sensor 135A, the emitter-sensor pair 115B includes the light emitter 132B and the sensor 135B, and the emitter-sensor pair 115C incudes the light emitter 132C and the sensor 135C. As illustrated in FIG. 6, the LiDAR system 100 also includes a short-range LiDAR system 170, which has at least one light emitter and at least one detector (not labeled in FIG. 6, but shown in the same patterns as the light emitters 132 and the sensors 135). The emitter of the short-range LiDAR system 170 has a FOV 102A, and the sensor of the short-range LiDAR system 170 has a FOV 102B. As shown in FIG. 6, the FOV 102A and FOV 102B mostly overlap. (As explained above, due to the physical distance between the emitter and the sensor, the FOVs 102 do not overlap perfectly.) The short-range LiDAR system 170 can detect objects that are within the hazardous range 120 but in the blind spots of the emitter-sensor pair 115A, the emitter-sensor pair 115B, and the emitter-sensor pair 115C (as well as blind spots of other emitter-sensor pairs 115 whose FOVs 102 overlap the FOV 102A and FOV 102B). The approach in FIG. 6 can be used not only to improve eye safety (e.g., by detecting objects that are within the FOV 102 of an light emitter 132 but not within the FOV 102 of any sensor 135, such as the region 104A), but also to detect the presence of objects in the blind spots of the long-range system (e.g., such as the region 104B).

FIG. 7 illustrates another example approach to detect objects and improve eye safety within the hazardous range 120 areas that are closer to the LiDAR system 100 than the minimum detectable range 112. The example embodiment illustrated in FIG. 7 uses at least one wide-FOV detector 139 that has a FOV 102A in accordance with some embodiments. The least one wide-FOV detector 139, which may be referred to as a “probe detector,” can probe (or sense) the areas (volumes of space) that are illuminated by the light emitter 132A, light emitter 132B, light emitter 132C (and any other light emitters 132 of the LiDAR system 100 that illuminate the FOV 102A) but are outside of the FOVs 102 of the corresponding sensors 135 (e.g., APDs). The least one wide-FOV detector 139 can detect objects in the hazardous range 120 that are illuminated by the probe shots of the light emitter 132A, light emitter 132B, light emitter 132C (and any other light emitter 132 or light emitters 101 of the LiDAR system 100 that illuminate the FOV 102A). Therefore, the least one wide-FOV detector 139 can improve eye safety of objects in regions that are illuminated by the light emitter 132A, the light emitter 132B, and/or the light emitter 132C, but not sensed by any of the sensor 135A, the sensor 135B, or the sensor 135C. Specifically, the least one wide-FOV detector 139 can detect objects within the region 104A, the region 104B, and the region 104C.

FIGS. 8A and 8B together illustrate a flow diagram of an example of a method 200 using both first-order and second-order protection in accordance with some embodiments. The steps of the method 200 may be performed independently in each FOV 102. In other words, a LiDAR system 100 may perform the method 200 separately and/or in parallel in multiple FOVs 102. The block 202, block 204, block 206, block 208, and block 210 apply first-order protection, and the block 212, block 214, block 216, block 218, block 220, block 222, block 224, and block 226 apply second-order protection. As explained above, both first-order and second-order protection can be applied, or only first-order protection can be applied, or only second-order protection can be applied. It is also to be appreciated that different levels of protection can be applied in different directions (e.g., both first-order and second-order protection in some directions, only second-order protection in other directions, only first-order protection in yet other directions, etc.). Accordingly, the method 200 can end after block 210. As another example, the method 200 can start at block 212. Thus, block 202, block 204, block 206, block 208, and block 210 are optional when second-order protection is being applied, and block 212, block 214, block 216, block 218, block 220, block 222, block 224, and block 226 are optional when first-order protection is being applied.

At block 202, the one or more object-detection components 103 for the FOV are activated (“Sensor ON”). At block 204, the activated one or more object-detection components 103 scan (e.g., emit light) to scan the FOV for objects within the shutdown range 110. At block 206, it is determined from detected return signals whether any objects are within the shutdown range 110. If so, then at block 208, some or all light emitters 101 used in the normal operation of the LiDAR system 100 (e.g., either all of the higher-powered light emitters 101 in the LiDAR system 100, or some or all of the light emitters 101 that are illuminating the FOVs 102 of the shutdown range 110 in which the object was (or objects were) detected) are shut down (e.g., prevented from emitting light). An output (e.g., one or more coordinates of an object or target) can be provided to the output block 228 shown in FIG. 8B. At block 210, the activated one or more object-detection components 103 continue scanning, and the method 200 returns to block 206.

If, at block 206, the LiDAR system 100 did not detect any objects in the shutdown range, the LiDAR system 100 proceeds to determine whether to apply second-order protection (e.g., in embodiments that include both first-order protection and second-order protection). At block 212, probe shot scanning (e.g., as described in the context of one or more of FIGS. 2-7) is performed. At block 214, it is determined whether any objects were detected within the hazardous range 120. If so, the light emitters 101 used for probe shot scanning continue to transmit at the power level set for probe shots, thereby returning to block 212. An output (e.g., one or more coordinates of an object or target) can be provided to the output block 228 shown in FIG. 8B. If, at block 214, no object was detected within the hazardous range 120, then at block 216, the main system 150 (e.g., the light emitters 101) scans at full power and using full pulse sequences.

Block 218, block 220, block 222, block 224, and block 226 describe one way that return signals (e.g., reflections of emitted pulse sequences) can be processed by the LiDAR system 100 in accordance with some embodiments. At block 218, the return signal is acquired. At block 220, it is determined whether the scan count is equal to a value, N, which is the number of shots used for ranging via averaging. If the scan count is equal to N, then at block 226, N-averaged ranging is performed, the result (e.g., raw data that can be further processed) is provided at the output block 228, and the method 200 returns to block 212. If, at block 220, the scan count is not equal to N, then at block 222 it is determined whether the scan count is equal to M, where M is an integer value less than or equal to N. M represents the number of shots used to perform ranging between the interval of N acquisition, where M<N. If at block 222 the scan count is determined to be equal to M, then at block 224, M-count averaging is performed, the result (e.g., raw data that can be further processed) is provided to the output block 228, and the method 200 returns to block 214. If, at block 222, the scan count is found not to be equal to M, then the method 200 returns to block 216, and the LiDAR system 100 continues to scan at full power and using full pulse sequences.

It is to be appreciated that block 218, block 220, block 222, block 224, and block 226 describe an example of how the return signal can be processed. There are many other ways, and the example shown in FIGS. 8A and 8B is not intended to be limiting.

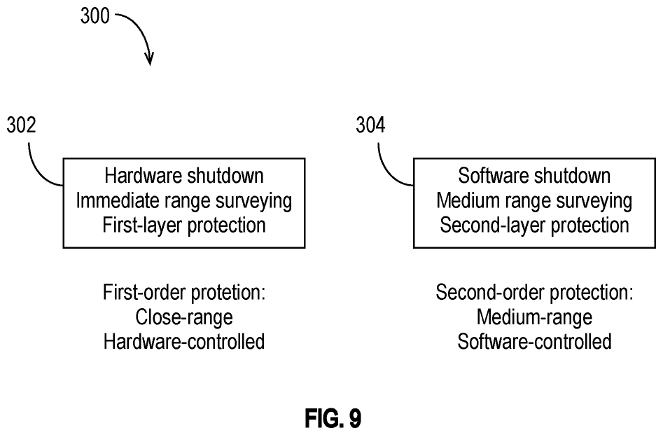

FIG. 9 illustrates an example system 300 that includes first- and second-order protection features and characteristics in accordance with some embodiments. On the left is first-order protection 302, which, as described herein, provides immediate-range (e.g., close-range) detection of objects and hardware-controlled shutdown (selective or non-selective) of light emitters 101 (e.g., lasers) that might be harmful to the detected objects. On the right is second-order protection 304, which, as described herein, provides medium-range detection of objects and software-controlled power reduction of selected light emitters 101 (e.g., lasers) that might be harmful to the detected objects.

The disclosures herein are in the context of LiDAR systems, and the described emitters (e.g., light emitters 101, light emitters 132, etc.) are generally assumed to be lasers, but it is to be appreciated that the techniques and approaches described herein can be used for other types of light-emitting systems (e.g., other than LiDAR) and with other types of light-emitting sources (e.g., other than lasers). In general, the disclosures herein can be used to improve the safety of any type of system that emits signals that might be harmful to nearby entities (e.g., people, animals, etc.).

In the foregoing description and in the accompanying drawings, specific terminology has been set forth to provide a thorough understanding of the disclosed embodiments. In some instances, the terminology or drawings may imply specific details that are not required to practice the invention.

To avoid obscuring the present disclosure unnecessarily, well-known components are shown in block diagram form and/or are not discussed in detail or, in some cases, at all.

Unless otherwise specifically defined herein, all terms are to be given their broadest possible interpretation, including meanings implied from the specification and drawings and meanings understood by those skilled in the art and/or as defined in dictionaries, treatises, etc. As set forth explicitly herein, some terms may not comport with their ordinary or customary meanings.

As used in the specification and the appended claims, the singular forms “a,” “an” and “the” do not exclude plural referents unless otherwise specified. The word “or” is to be interpreted as inclusive unless otherwise specified. Thus, the phrase “A or B” is to be interpreted as meaning all of the following: “both A and B,” “A but not B,” and “B but not A.” Any use of “and/or” herein does not mean that the word “or” alone connotes exclusivity.

As used in the specification and the appended claims, phrases of the form “at least one of A, B, and C,” “at least one of A, B, or C,” “one or more of A, B, or C,” and “one or more of A, B, and C” are interchangeable, and each encompasses all of the following meanings: “A only,” “B only,” “C only,” “A and B but not C,” “A and C but not B,” “B and C but not A,” and “all of A, B, and C.”

To the extent that the terms “include(s),” “having,” “has,” “with,” and variants thereof are used in the detailed description or the claims, such terms are intended to be inclusive in a manner similar to the term “comprising,” i.e., meaning “including but not limited to.”

The terms “exemplary” and “embodiment” are used to express examples, not preferences or requirements. The term “coupled” is used herein to express a direct connection/attachment as well as a connection/attachment through one or more intervening elements or structures.

The terms “over,” “under,” “between,” and “on” are used herein refer to a relative position of one feature with respect to other features. For example, one feature disposed “over” or “under” another feature may be directly in contact with the other feature or may have intervening material. Moreover, one feature disposed “between” two features may be directly in contact with the two features or may have one or more intervening features or materials. In contrast, a first feature “on” a second feature is in contact with that second feature.

The term “substantially” is used to describe a structure, configuration, dimension, etc. that is largely or nearly as stated, but, due to manufacturing tolerances and the like, may in practice result in a situation in which the structure, configuration, dimension, etc. is not always or necessarily precisely as stated. For example, describing two lengths as “substantially equal” means that the two lengths are the same for all practical purposes, but they may not (and need not) be precisely equal at sufficiently small scales.

The drawings are not necessarily to scale, and the dimensions, shapes, and sizes of the features may differ substantially from how they are depicted in the drawings.

Although specific embodiments have been disclosed, it will be evident that various modifications and changes may be made thereto without departing from the broader spirit and scope of the disclosure. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

1. A system, comprising:
a first light emitter configured to illuminate a first field of view (FOV) using light emitted at a first wavelength;
a second light emitter configured to illuminate a second FOV using light emitted at a second wavelength, wherein the second FOV is wider than the first FOV, and wherein the first FOV extends to a further distance from the system than the second FOV;
a sensor configured to detect reflections off of targets within the second FOV; and
at least one processor configured to execute one or more machine-executable instructions that, when executed, cause the at least one processor to:
cause the second light emitter to illuminate the second FOV using light emitted at the second wavelength,
determine whether the sensor detected an object within the second FOV, and
in response to determining that the sensor detected the object within the second FOV, prevent the first light emitter from illuminating the first FOV.

2. The system recited in claim 1, wherein the second wavelength is longer than the first wavelength.

3. The system recited in claim 2, wherein (a) the second wavelength is greater than approximately 1500 nm, or (b) the second wavelength is in an 800-nm or a 900-nm band.

4. (canceled)

5. The system recited in claim 1, wherein a portion of the first FOV overlaps a portion of the second FOV.

6. The system recited in claim 1, wherein preventing the first light emitter from illuminating the first FOV comprises causing the first light emitter to shut down.

7. The system recited in claim 1, wherein the first light emitter is one of a plurality of light emitters of a main system, and the second light emitter is included in an auxiliary system.

8. The system recited in claim 7, wherein the auxiliary system comprises at least one range finder, and wherein the second light emitter is included in the at least one range finder.

9. The system recited in claim 7, wherein the auxiliary system comprises a LiDAR system, and wherein the second light emitter is included in the LiDAR system.

10. The system recited in claim 9, wherein the second light emitter comprises a Class 1 laser.

11. The system recited in claim 7, wherein preventing the first light emitter from illuminating the first FOV comprises shutting down a subset of the plurality of light emitters of the main system, wherein the subset of the plurality of light emitters illuminates the first FOV.

12. The system recited in claim 7, wherein preventing the first light emitter from illuminating the first FOV comprises shutting down the plurality of light emitters of the main system.

13. The system recited in claim 1, wherein the system is a light detection and ranging (LiDAR) system, and wherein the second wavelength is greater than approximately 1500 nm.

14. The system recited in claim 1, wherein at least one of the first light emitter or the second light emitter comprises a laser.

15. The system recited in claim 1, wherein the sensor comprises a photodiode.

16. The system recited in claim 1, wherein the first light emitter is configured to operate in at least two modes, the at least two modes including (a) a full-power, full-sequence mode and (b) a reduced-power mode, and wherein, when executed by the at least one processor, the one or more machine-executable instructions further cause the at least one processor to:
in response to determining that the sensor did not detect the object within the second FOV, cause the first light emitter to emit one or more probe shots in the reduced-power mode,
determine, based on reflections of the one or more probe shots, whether the object is within a hazardous range of the system within the first FOV, and
in response to determining that the object is not within the hazardous range of the system within the first FOV, cause the first light emitter to operate in the full-power, full-sequence mode.

17. The system recited in claim 16, wherein the one or more probe shots comprise emissions at lower peak power and/or with fewer pulses than emissions in the full-power, full-sequence mode.

18. The system recited in claim 16, wherein, when executed by the at least one processor, the one or more machine-executable instructions further cause the at least one processor to:
in response to determining that the object is within the hazardous range of the system within the first FOV, cause the first light emitter to continue to operate in the reduced-power mode.

19. The system recited in claim 16, wherein the sensor is a first sensor, and further comprising:
a second sensor configured to detect a third FOV, the third FOV being wider than and overlapping a portion of the first FOV;
and wherein, when executed by the at least one processor, the one or more machine-executable instructions further cause the at least one processor to:
determine whether the second sensor detected a target within the third FOV.

20. The system recited in claim 19, wherein, when executed by the at least one processor, the one or more machine-executable instructions further cause the at least one processor to:
in response to determining that the second sensor detected the target within the third FOV, cause the first light emitter to continue to operate in the reduced-power mode.

21. The system recited in claim 19, further comprising a third light emitter, and wherein, when executed by the at least one processor, the one or more machine-executable instructions further cause the at least one processor to:
cause the third light emitter to illuminate a fourth FOV, wherein the fourth FOV is wider than the first FOV, and wherein the fourth FOV overlaps the first FOV and the third FOV.

22. The system recited in claim 21, wherein the third light emitter and the second sensor are included in a LiDAR system.

23. The system recited in claim 21, wherein the third light emitter is the second light emitter, and the third FOV is the second FOV.

24. A method performed by a light-emitting system to improve eye safety of the light-emitting system, the method comprising:
a first light emitter illuminating a first field of view (FOV) using light emitted at a first wavelength;
a second light emitter illuminating a second FOV using light emitted at a second wavelength, wherein the second FOV is wider than the first FOV, and
wherein the first FOV extends to a further distance from the light-emitting system than the second FOV;
determining whether an object is within the second FOV; and
in response to determining that the object is within the second FOV, shutting down the first light emitter.

25. The method of claim 24, wherein the second wavelength is longer than the first wavelength.

26. The method of claim 25, wherein the second wavelength is greater than approximately 1500 nm.

27. The method of claim 24, wherein a portion of the first FOV overlaps a portion of the second FOV.

28. The method of claim 24, wherein the first light emitter is one of a plurality of light emitters of a main system, and the second light emitter is included in an auxiliary system.

29. The method of claim 28, wherein the auxiliary system comprises at least one range finder, and wherein the second light emitter is included in the at least one range finder.

30. The method of claim 28, wherein the auxiliary system comprises a LiDAR system, and wherein the second light emitter is included in the LiDAR system.

31. The method of claim 30, wherein the second light emitter comprises a Class 1 laser.

32. The method of claim 28, wherein shutting down the first light emitter comprises shutting down a plurality of light emitters of the main system.

33. The method of claim 24, wherein the first light emitter is configured to operate in at least two modes, the at least two modes including (a) a full-power, full-sequence mode and (b) a reduced-power mode, and further comprising:
in response to determining that the object is not within the second FOV, the first light emitter emitting one or more probe shots in the reduced-power mode;
determining, based on reflections of the one or more probe shots, whether the object is within a hazardous range of the light-emitting system within the first FOV; and
in response to determining that the object is not within the hazardous range of the light-emitting system within the first FOV, the first light emitter transitioning to operate in the full-power, full-sequence mode.

34. The method of claim 33, wherein emitting the one or more probe shots in the reduced-power mode comprises emitting light at lower peak power and/or with fewer pulses than in the full-power, full-sequence mode.

35. The method of claim 33, further comprising:
in response to determining that the object is within the hazardous range of the light-emitting system within the first FOV, the first light emitter continuing to operate in the reduced-power mode.

36. An object-detection system, comprising:
a first light emitter configured to illuminate a first field of view (FOV), wherein the first light emitter is configured to operate in at least two modes, the at least two modes including (a) a full-power, full-sequence mode and (b) a reduced-power mode;
a sensor configured to provide a signal indicating presence and/or absence of targets within the first FOV; and
at least one processor configured to execute one or more machine-executable instructions that, when executed, cause the at least one processor to:
cause the first light emitter to emit one or more probe shots in the reduced-power mode,
determine, based on the signal from the sensor, whether there is an object within a hazardous range of the object-detection system within the first FOV, and
in response to determining that there is no object within the hazardous range of the object-detection system within the first FOV, cause the first light emitter to operate in the full-power, full-sequence mode.

37. The object-detection system recited in claim 36, wherein: (a) the one or more probe shots comprise emissions at lower peak power than emissions in the full-power, full-sequence mode, or (b) the one or more probe shots comprise emissions with fewer pulses than emissions in the full-power, full-sequence mode.

38. (canceled)

39. The object-detection system recited in claim 36, wherein, when executed by the at least one processor, the one or more machine-executable instructions further cause the at least one processor to:
in response to determining that the object is within the hazardous range of the object-detection system within the first FOV, cause the first light emitter to continue to operate in the reduced-power mode.

40. The object-detection system recited in claim 36, wherein the sensor is a first sensor, and further comprising:
a second sensor configured to detect a second FOV, the second FOV being wider than and overlapping a portion of the first FOV;
and wherein, when executed by the at least one processor, the one or more machine-executable instructions further cause the at least one processor to:
determine whether the second sensor detected a target within the second FOV.

41. The object-detection system recited in claim 40, wherein, when executed by the at least one processor, the one or more machine-executable instructions further cause the at least one processor to:
in response to determining that the second sensor detected the target within the second FOV, cause the first light emitter to continue to operate in the reduced-power mode.

42. The object-detection system recited in claim 40, further comprising a third light emitter, and wherein, when executed by the at least one processor, the one or more machine-executable instructions further cause the at least one processor to:
cause a second light emitter to illuminate a third FOV, wherein the third FOV is wider than the first FOV, and wherein the third FOV overlaps the first FOV and the second FOV.

43. The object-detection system recited in claim 42, wherein the second light emitter and the second sensor are included in a LiDAR system.
